(19) United States
(12) Patent Application Publication
(10) Pub. No.: US 2025/0282531 A1
(43) Pub. Date: Sep. 11, 2025

(54) PORTABLE CONTAINER SYSTEM

(71) Applicant: YETI Coolers, LLC, Austin, TX (US)

(72) Inventors: Dustin R. Bullock, Austin, TX (US); Melissa Cosler, Austin, TX (US); Mark D. Miller, San Marcos, TX (US)

(21) Appl. No.: 18/601,555

(22) Filed: Mar. 11, 2024

(51) Int. Cl. B65D 45/20; B65D 43/06; B65D 53/02

(52) U.S. Cl. CPC B65D 45/20; B65D 43/065; B65D 53/02; B65D 2543/00101; B65D 2543/00972

(57) ABSTRACT

A container system comprises a container that includes a container body with a storage cavity and a lid assembly releasably connected to the container. The lid assembly has a lid that includes a gasket received in a channel on the lid, and a latch pivotally connected to the lid. The container may also include a perimeter lip extending outward around an entire perimeter of the container opening of the container. The latch may include a latch rib, such that when the latch is engaged with the perimeter lip of the container, the latch rib is located over the channel of the lid. The channel on the lid that receives the gasket may also include a channel rib.

### FIELD OF THE INVENTION

This disclosure relates to portable containers. More specifically, aspects of this disclosure relate to a portable container with a lid, where when the container is in a closed configuration, the container provides a waterproof and airtight seal.

### BACKGROUND

Portable containers are commonly used to store various items such as food or liquids. The containers may also provide a degree of protection from incidental impacts (e.g., drops) as well as from incursion from liquids or dirt. By sealing the container, the contents are prevented from leaking onto other items when stored and also protected from incursion into the contents. Containers may be composed of rigid materials and have an opening that may be sealed with a lid.

### BRIEF SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

This disclosure may relate to a portable container that includes a container system, comprising: (a) a container including: (1) a first wall; (2) a second wall opposite the first wall; (3) a third wall extending between the first wall and the second wall; (4) a fourth wall opposite the third wall extending between the first wall and the second wall; and (5) a bottom wall connected to the first wall, the second wall, the third wall, and the fourth wall at a bottom end of the container forming a storage cavity with a container opening opposite the bottom wall; and (b) a lid assembly releasably connected to the container, where the lid assembly covers the container opening when connected to the container, and where the lid assembly comprises: (1) a lid that includes a top surface and a channel on a bottom side of the lid; (2) a gasket received in the channel; and (3) a latch pivotally connected to the lid. The container may also include a perimeter lip extending outward around a portion of a perimeter of the container opening, where the perimeter lip includes a lip protrusion extending from a lower surface of the perimeter lip. The latch may include a latch rib, such that when the latch is engaged with the perimeter lip of the container, the latch rib is located over the channel of the lid. The channel may also include an upper surface that has a channel rib that extends away from the upper surface toward the bottom side of the lid, where the latch rib and the channel rib are substantially aligned when the latch is engaged with the perimeter lip of the container. The container may also include a container rib that extends upward and away from an upper surface of the perimeter lip. In some examples, the container rib may be substantially aligned with the channel rib and the latch rib. The channel may form a continuous loop, and the channel rib may also form a continuous loop. The container rib and the channel rib may contact the gasket on opposite sides of the gasket. In addition, the latch rib may contact an outward facing surface of the lid opposite the channel. The lid may comprise a receiver that includes a first axle that extends from a first side surface of the receiver and a second axle that extends from a second side surface of the receiver. The first axle may include a cylindrical portion and an end cap at a free end, where an axle clip of the latch connects to the cylindrical portion, and where the end cap has a maximum width that is larger than a diameter of the cylindrical portion. The latch may include a top wall connected to a side wall, where the side wall is substantially perpendicular to the top wall, and the side wall has a flange that engages the perimeter lip. The latch rib may extend outward from an inner surface of the top wall. Additionally, the latch may have a latch length extending from a first end of the top wall to a second end of the top wall, and the latch rib may have a latch rib length, where the latch rib length is within a range of 85 percent to 98 percent of the latch length.

Other aspects of this disclosure may relate to a lid assembly for a covering an opening of a container, the lid assembly comprising: (a) a lid that includes a top surface and a channel on a bottom side of the lid, where the channel includes an upper surface that has a channel rib that extends away from the upper surface toward the bottom side of the lid; (b) a gasket received in the channel; and (c) a latch pivotally connected to the lid, where the latch is configured to rotate between a locked configuration and an unlocked configuration. The latch may include a latch rib, such that when the latch is in the locked configuration the latch rib contacts an outward facing surface of the lid opposite the channel, and when the latch is in the unlocked configuration, the latch rib is free of contact with the outward facing surface of the lid opposite the channel. The latch rib and the channel rib may be substantially aligned when the latch is in the locked configuration. The latch may also include a top wall connected to a side wall, where the side wall is substantially perpendicular to the top wall. The side wall may include a flange that is configured to engages a perimeter lip of the container when the latch is in the locked configuration. The latch rib may be configured to apply a force to the gasket through the channel rib when the latch is moved to the locked configuration.

Still other aspects of this disclosure may relate to a container system, comprising: (a) a container that includes (1) a container body including a storage cavity that is accessed through a container opening, (2) a perimeter lip extending laterally outward around at least a portion of a perimeter of the container opening, where the perimeter lip includes: a lip protrusion extending from a lower surface of the perimeter lip; and a container rib that extends upward and away from an upper surface of the perimeter lip; and (b) a lid assembly releasably connected to the container, where the lid assembly covers the container opening when connected to the container opening. The lid assembly may comprise: (1) a lid that includes a top surface; a channel located on a bottom side of the lid, where the channel includes an upper surface that has a channel rib that extends away from the upper surface toward the bottom side of the lid; and a plurality of receivers positioned laterally outward of the top surface, where a first receiver of the plurality of receivers may include a first side surface and a second side surface, and where a first axle extends from the first side surface and a second axle extends from the second side surface; (2) a gasket received in the channel; and (3) a plurality of latches, where a first latch of the plurality of latches includes a top wall, a side wall connected to the top wall, and a pair of axle clips extending from an inner surface of the top wall, wherein the side wall includes a flange that engages a bottom surface of the lip protrusion of the perimeter lip when the container system is in a locked configuration to compress the gasket between the container rib and the channel rib. The first axle may include a cylindrical portion and an end cap at a free end, where an axle clip of the pair of axle clips connects to the cylindrical portion. The first latch may further include a curved wall connected to the top wall opposite the side wall, where the curved wall has an outer surface that includes a restraint wall such that when the first latch is rotated upward to an unlocked configuration, the restraint wall may contact a protrusion extending upward from an upward facing surface of the first receiver. The first latch may further include a latch rib that extends from the inner surface of the top wall, such that when the first latch is in the locked configuration, the latch rib contacts an outward facing surface of the lid opposite the channel. The channel may be located laterally outward of the first axle and the second axle of each receiver.

### BRIEF DESCRIPTION OF THE DRAWINGS

FIG. 1 depicts a top, right front perspective view of the portable container system in a locked configuration according to aspects disclosed herein;

FIG. 2 depicts a bottom, right front perspective view of the portable container system of FIG. 1 according to aspects disclosed herein;

FIG. 3 depicts a top view of the portable container system of FIG. 1 according to aspects disclosed herein;

FIG. 4 depicts a front view of the portable container system of FIG. 1 according to aspects disclosed herein;

FIG. 5 depicts a right side view of the portable container system of FIG. 1 according to aspects disclosed herein;

FIG. 6 depicts cross-sectional view of the portable container system of FIG. 4 along line 6-6 according to aspects disclosed herein;

FIG. 7 depicts an enlarged view of a portion of the portable container system of FIG. 6 according to aspects disclosed herein;

FIG. 8 depicts a top, rear perspective view of the portable container system of FIG. 1 in an unlocked configuration according to aspects disclosed herein;

FIG. 9 front view of the portable container system of FIG. 8 according to aspects disclosed herein;

FIG. 10 depicts a cross-sectional view of the portable container system of FIG. 8 along line 10-10 according to aspects disclosed herein;

FIG. 11 depicts an enlarged view of a portion of the cross-sectional view of the portable container system of FIG. 8 according to aspects disclosed herein;

FIG. 12 depicts an enlarged partial perspective view of the portable container system of FIG. 8 according to aspects disclosed herein;

FIG. 13 depicts a top, front perspective view of the lid of the portable container system of FIG. 1 according to aspects disclosed herein;

FIG. 14 depicts a bottom, front perspective view of the lid of the portable container system of FIG. 13 according to aspects disclosed herein;

FIG. 15 depicts a top view of the lid of the portable container system of FIG. 13 according to aspects disclosed herein;

FIG. 16 depicts an enlarged partial perspective view of the lid of the portable container system of FIG. 13 according to aspects disclosed herein;

FIG. 17 depicts an enlarged partial top view of the lid of the portable container system of FIG. 13 according to aspects disclosed herein;

FIG. 18 depicts a partial side cross-sectional view of the lid of the portable container system of FIG. 15 along line 18-18 according to aspects disclosed herein;

FIG. 19 depicts a top, front perspective view of a latch of the portable container system of FIG. 1 according to aspects disclosed herein;

FIG. 20 depicts a bottom, rear perspective view of the latch of FIG. 19 according to aspects disclosed herein;

FIG. 21 depicts a side view of the latch of FIG. 19 according to aspects disclosed herein;

FIG. 22 depicts a partial perspective view of the latch of FIG. 19 according to aspects disclosed herein;

FIG. 23 depicts a top, front perspective view of the container of the portable container system of FIG. 1 according to aspects disclosed herein;

FIG. 24 depicts a side view of the container of the portable container system of FIG. 23 according to aspects disclosed herein;

FIG. 25 depicts a top, front perspective view of an alternate portable container system in a locked configuration according to aspects disclosed herein; and

FIG. 26 depicts a top, front perspective view of an alternate portable container system in a locked configuration according to aspects disclosed herein.

### DETAILED DESCRIPTION

In the following description of various example structures, reference is made to the accompanying drawings, which form a part hereof, and in which are shown by way of illustration various example devices, systems, and environments in which aspects of the invention may be practiced. It is to be understood that other specific arrangements of parts, example devices, systems, and environments may be utilized and structural and functional modifications may be made without departing from the scope of the present disclosure.

Also, while the terms “top,” “bottom,” “front,” “side,” “rear,” and the like may be used in this specification to describe various example features and elements of the invention, these terms are used herein as a matter of convenience, e.g., based on the example orientations shown in the figures or the orientation during typical use. Additionally, the term “plurality,” as used herein, indicates any number greater than one, either disjunctively or conjunctively, as necessary, up to an infinite number.

The terms “connect,” or “attach” as used herein indicates that components, surfaces, or features and the like may be directly or indirectly (i.e. through an intermediary) joined, linked or attached. In addition, “pivotally connected” as used herein, indicates that the components or features are directly or indirectly coupled together such that the components can rotate relative to each other while still being coupled together either directly or indirectly. Examples of a “pivotally connected” joint may include a pin inserted into an opening arranged in each of the components to “pivotally connect” the components.

As used herein, the term “substantially” means mostly, or almost the same as, within the constraints of sensible commercial engineering objectives, costs, manufacturing tolerances, and capabilities in the field of manufacturing the article being formed. For example, the term, “substantially aligned,” as the term is used herein, means that a first line, segment, plane, edge, surface, center plane of an element, or center axis of an element, etc. is collinear or coplanar from with another line, plane, edge, surface, center plane of an element or center axis of an element, etc. in some instances within a tolerance range of +1 mm, or within a tolerance range of +2 mm, or within a tolerance range that is appropriate for manufacturing of the described elements. Similarly, the term “substantially coplanar” as used herein, indicates that the elements of any two or more surfaces or edges may fall within a tolerance zone of parallel planes in some instances within a tolerance range of +1 mm, or within a tolerance range of +2 mm, or within a tolerance range that is appropriate for manufacturing of the described elements.

The term “approximately” means close to, or about, a particular value, within the constraints of sensible commercial engineering objectives, costs, manufacturing tolerances, and capabilities in the field of manufacturing the article being formed.

“Substantially coplanar” as used herein, indicates that the elements of any two or more surfaces or edges fall within a tolerance zone of parallel planes within a range of +/−2 mm of each other.

“Substantially parallel,” as the term is used herein, means that a first line, segment, plane, edge, surface, etc. is approximately (in this instance, within 5%) equidistant from with another line, plane, edge, surface, etc., over at least 50% of the length of the first line, segment, or edge, or over at least 50% of the area of the plane or surface, etc. In some examples, lines, segments, or edges may be considered “substantially parallel” if one such a line, segment, or edge is approximately equidistant (65%) to another respective line, segment, or edge over at least 60%, at least 75%, at least 85%, at least 90%, or even at least 95% of a length of either of the lines, segments, or edges being considered. Additionally, planes or surfaces may be considered “substantially parallel” if one plane or surface is approximately equidistant (65%) to another respective plane or surface over at least 60%, at least 75%, at least 85%, at least 90%, or even at least 95% of a surface area of either of the planes or surfaces being considered.

“Substantially perpendicular,” as the term is used herein, means that a first line, segment, plane, edge, surface, etc. is approximately (in this instance, within 5%) orthogonal from with another line, plane, edge, surface, etc., over at least 50% of the length of the first line, segment, or edge, or over at least 50% of the area of the plane or surface, etc. In some examples, lines, segments, or edges may be considered “substantially perpendicular” if one such a line, segment, or edge is approximately orthogonal (65%) to another respective line, segment, or edge over at least 60%, at least 75%, at least 85%, at least 90%, or even at least 95% of a length of either of the lines, segments, or edges being considered. Additionally, planes or surfaces may be considered “substantially perpendicular” if one plane or surface is approximately orthogonal (65%) to another respective plane or surface over at least 60%, at least 75%, at least 85%, at least 90%, or even at least 95% of a surface area of either of the planes or surfaces being considered.

Nothing in this specification should be construed as requiring a specific three dimensional orientation of structures in order to fall within the scope of this invention. The reader is advised that the attached drawings are not necessarily drawn to scale.

Generally, this disclosure relates to a portable container system that includes a container and a lid assembly, where the container system may have a locked configuration that prevents access to the storage cavity of the container and an unlocked configuration that allows the lid assembly to be removed from the container to allow access to the storage cavity.

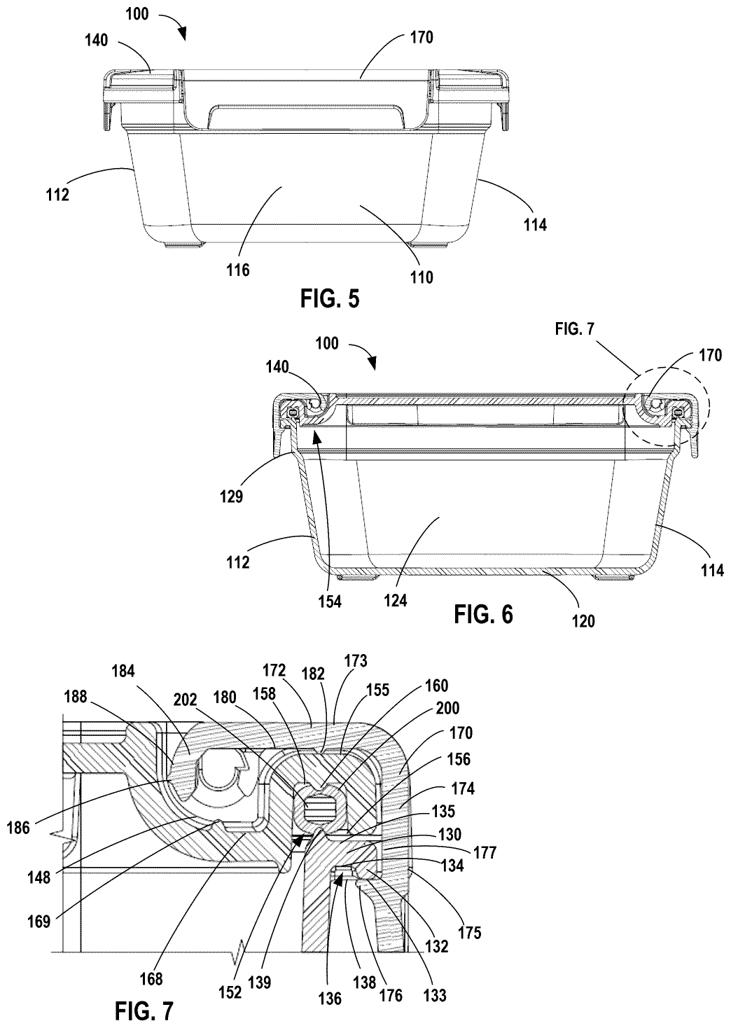

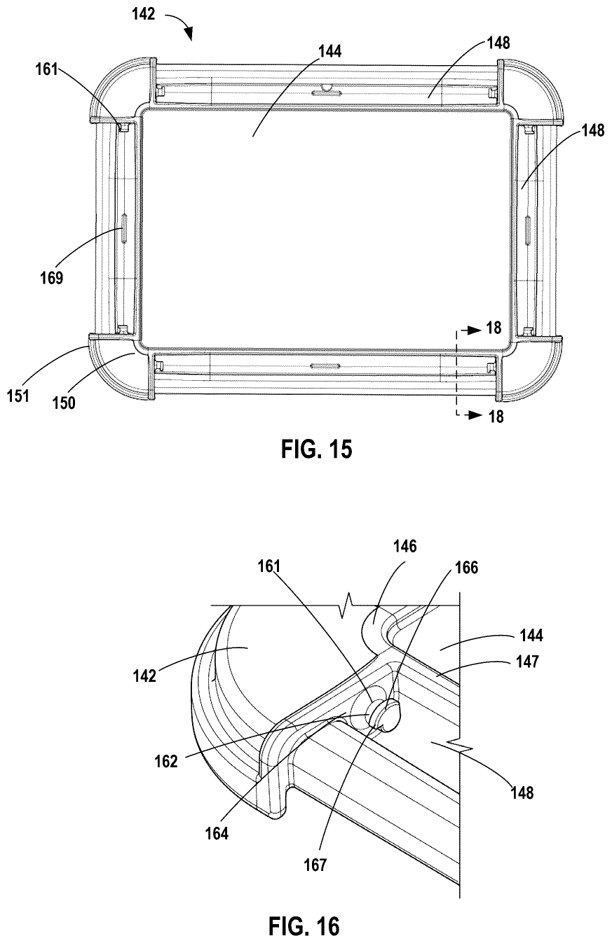

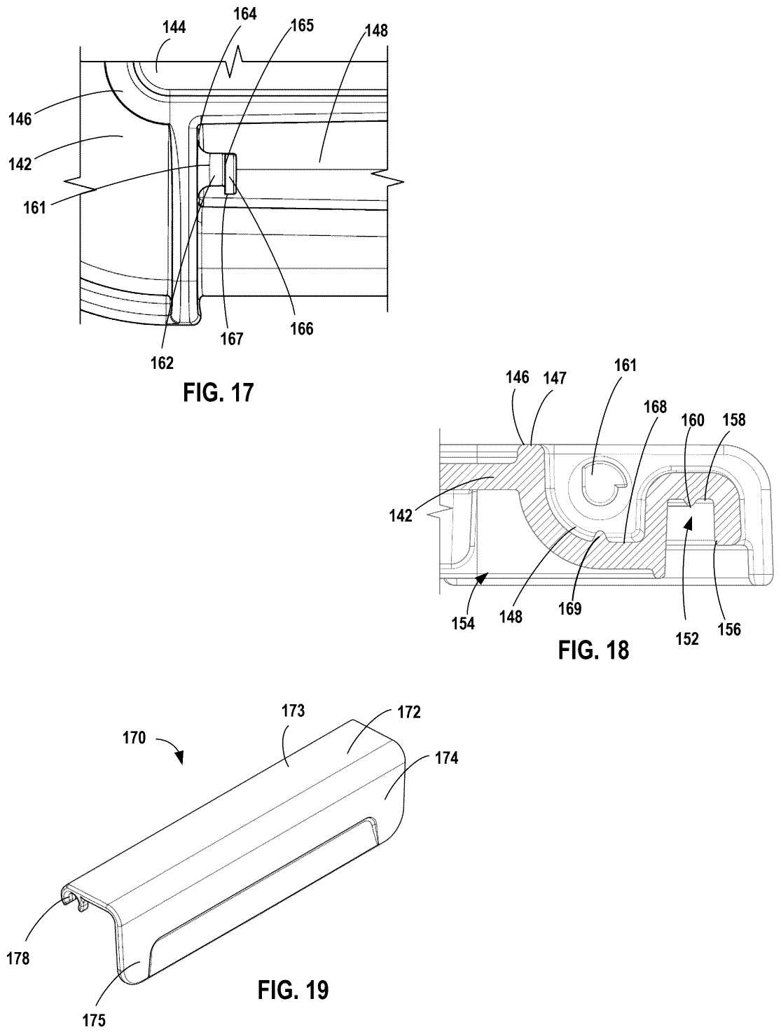

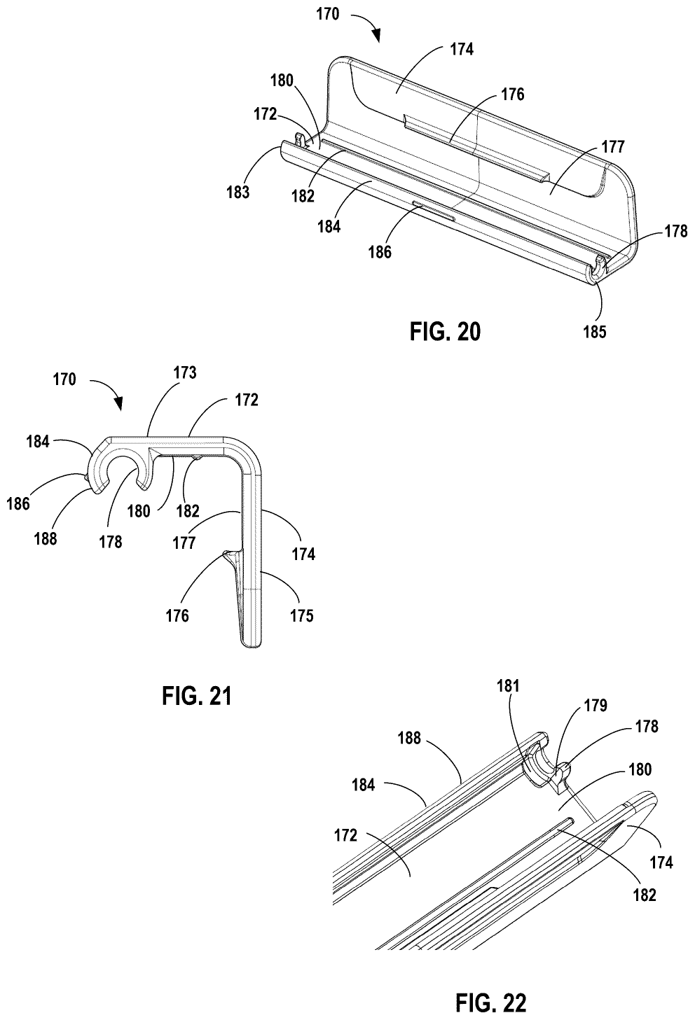

As shown in FIGS. 1-24, the portable container system 100 may comprise a container 110 and a lid assembly 140 that is releasably connected with the container 110. The container system 100 may have an unlocked configuration that allows for the removal of the lid assembly 140, and a locked configuration that prevents the removal of the lid assembly 140. The lid assembly 140 may also comprise a plurality of latches 170 that may be pivotally connected to the lid 142. Each latch 170 may engage a perimeter lip 130 on the container 110 when the container system 100 is in a locked configuration, and a latch 170 may be disengaged (e.g., free of contact) from the perimeter lip 130 of the container 110 when the container system 100 is in an unlocked configuration.

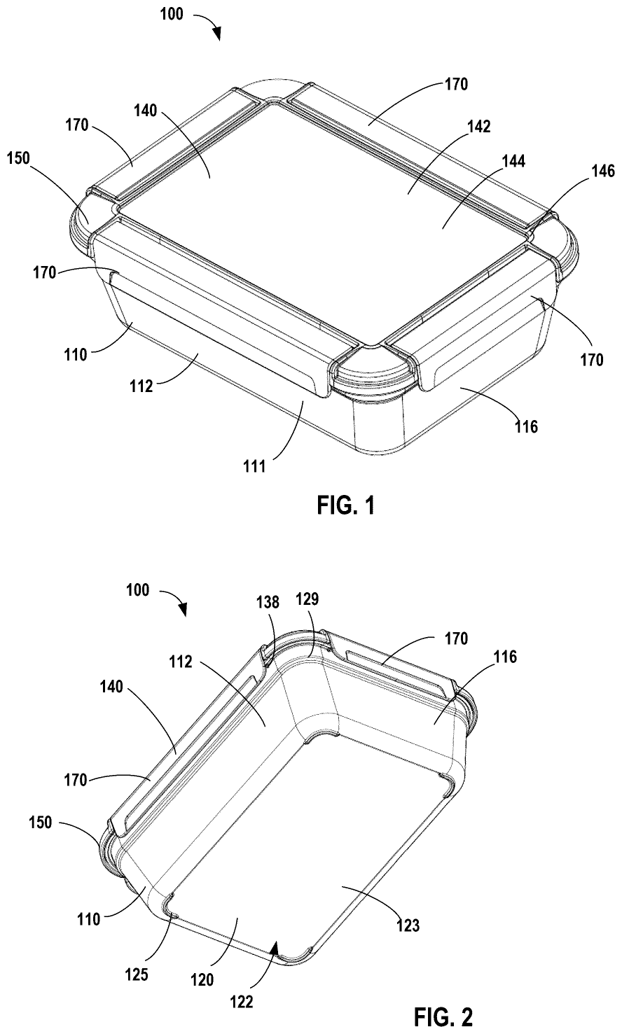

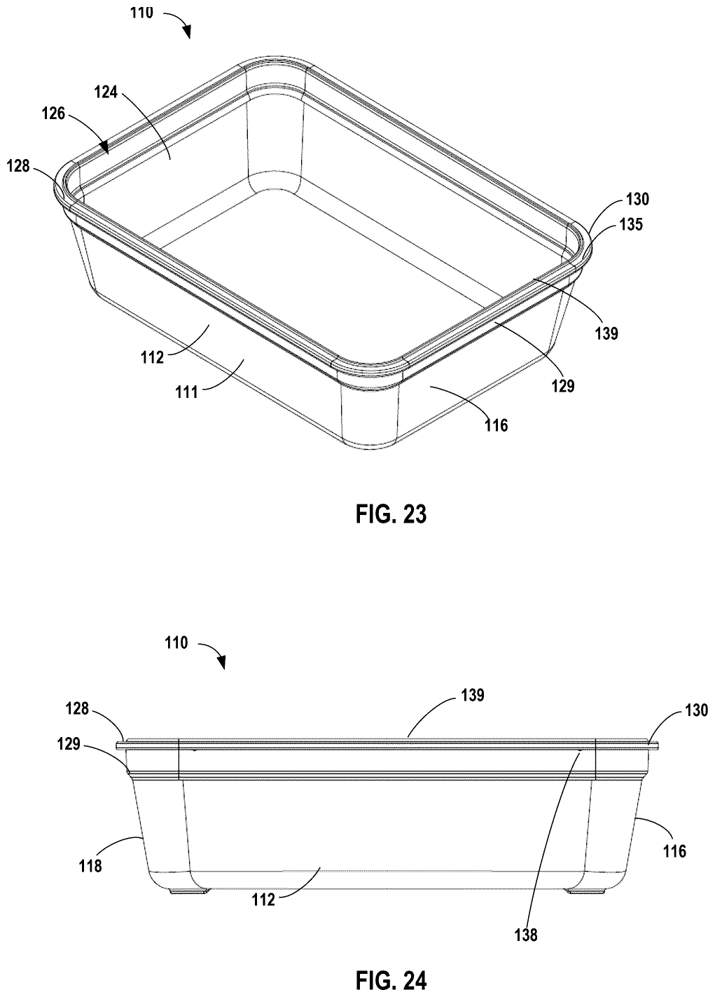

The container 110 may have a container body 111 that has a storage cavity 124 that is accessed through a container opening 126. While the container 110 in the illustrated examples has a substantially rectangular profile, the container 110 is not limited to a rectangular profile as the container 110 may have a substantially circular profile, a substantially elliptical profile, or other geometric shape. The exemplary container body 111 may have a first wall 112, a second wall 114 opposite the first wall 112, a third wall 116 extending between the first wall 112 and the second wall 114, and a fourth wall 118 opposite the third wall 116 extending between the first wall 112 and the second wall 114. A bottom wall 120 may connect the first wall 112, the second wall 114, the third wall 116, and the fourth wall 118 at a bottom end 122 of the container 110 forming a storage cavity 124 with a container opening 126 opposite the bottom wall 120 at an upper end 128 of the container 110 as shown in FIG. 23. The walls 112, 114, 116, 118, 120 may be connected with a smooth juncture (e.g., rounded corners) such that the container body 111 is a smooth continuous structure. A perimeter lip 130 may extend laterally outward at the upper end 128 of the container 110, where the perimeter lip 130 may extend around an entire perimeter (e.g., the distance around the walls 112, 114, 116, 118) of the container opening 126 such that the perimeter lip 130 extends outward around the first wall 112, the second wall 114, the third wall 116, and the fourth wall 118 and forms a continuous loop. The perimeter lip 130 may include a lip protrusion 132 extending from a lower surface 134 of the perimeter lip 130, where the lip protrusion 132 extends downward and away from the lower surface 134 of the perimeter lip 130. A groove 136 may be formed between the perimeter lip 130 and the lip protrusion 132. The container 110 may include supports 138 that connect the lip protrusion 132 and its corresponding wall 112, 114, 116, 118 to help strengthen the perimeter lip 130 and lip protrusion 132. The bottom wall 120 may include a plurality of feet 125 that extend from the bottom surface 123 as shown in FIG. 2.

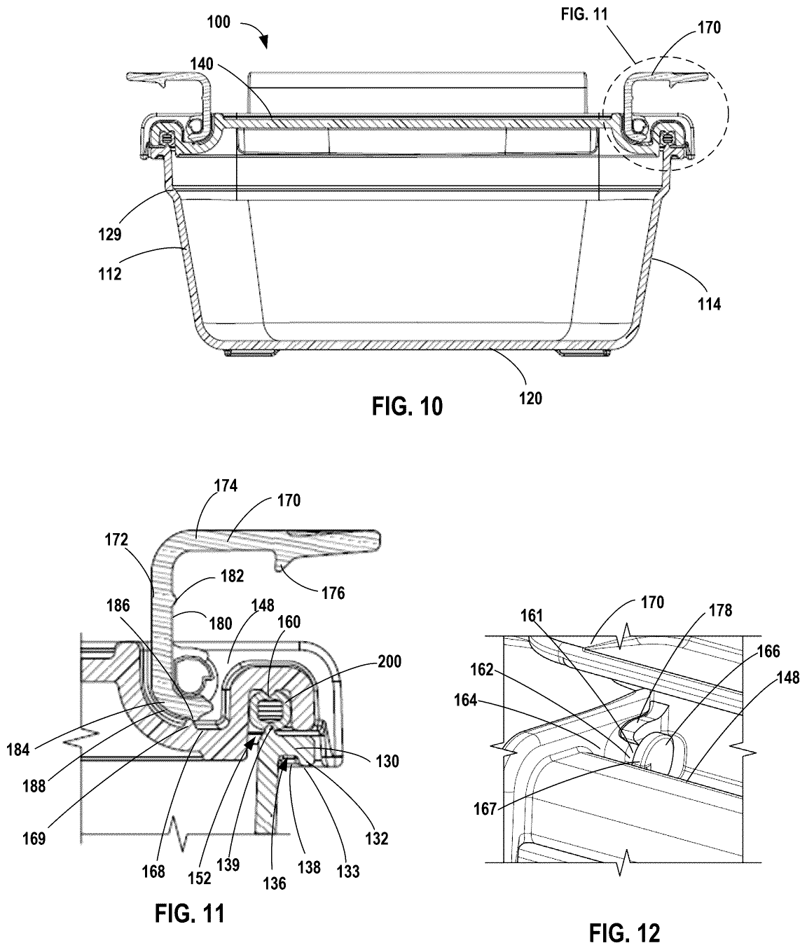

The lid assembly 140 may be removably connected to the container 110. When attached, the lid assembly 140 covers the container opening 126 of the container 110 and prevents access to the storage cavity 124. When the lid assembly 140 is removed, access to the storage cavity 124 is allowed. The lid assembly 140 may comprise a lid 142, a plurality of latches 170 that are pivotally connected to the lid 142 and a gasket 200. Each latch 170 may include a top wall 172 connected to a side wall 174, where the side wall 174 is substantially perpendicular to the top wall 172. The side wall 174 may further include a flange 176 that may extend laterally inward and away from an inner surface 177 of the side wall 174. The flange 176 may selectively engage the perimeter lip 130, such when the flange 176 engages the perimeter lip 130 and/or the lip protrusion 132 of the container 110, the latch 170 is in a locked configuration as shown in FIGS. 6 and 7, and when the flange 176 is free of contact with the lip protrusion 132 and/or the perimeter lip 130, the latch 170 is in an unlocked configuration as shown in FIGS. 10-11. When in latch 170 is in a locked configuration, the flange 176 may engage a bottom surface 133 of the lip protrusion 132. When the flange 176 engages the lip protrusion 132, a latch rib 182 on the top wall 172 may exert a downward force onto the gasket 200 positioned within a channel 152 on a bottom side 154 of the lid 142. In some embodiments, when the container system 100 is in the locked configuration, the lid 142 may be free of contact with the container 110, such that only the gasket 200 and the latches 170 contact both the lid 142 and the container 110. In some embodiments, various portions of the lid 142 may be in contact with the container 110 when the lid 142 is placed on the container 110. For example, one or more portions of the lid 142 may contact the perimeter lip 130 to align the lid 142 with the container 110.

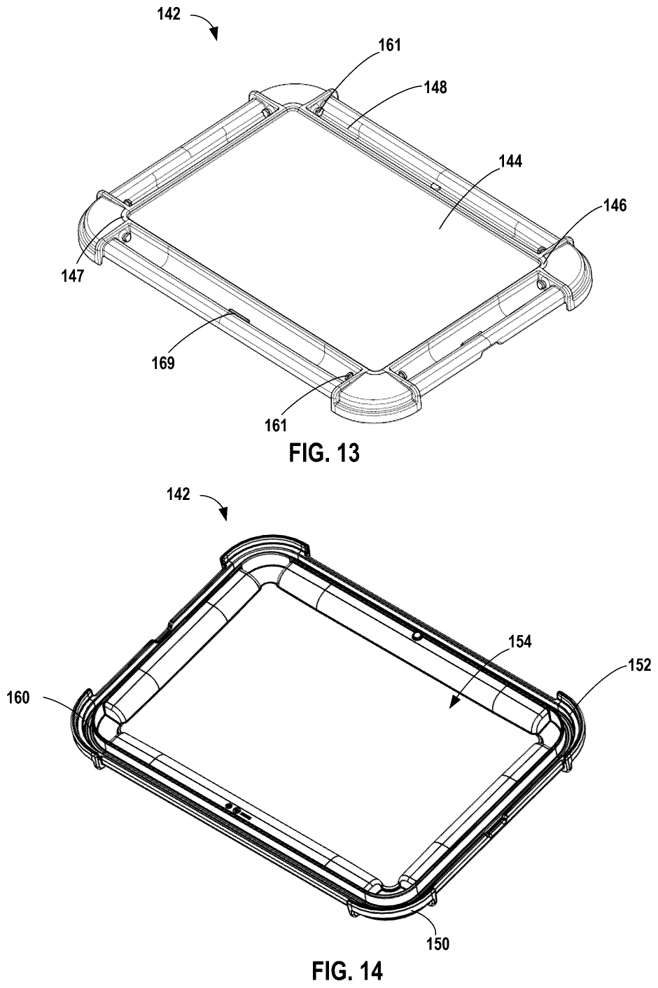

FIGS. 13-18 illustrate the lid 142 of the lid assembly 140. The lid 142 includes top surface 144, a lid protrusion 146 extending upward from and around an outer edge of the top surface 144. In some embodiments, the top surface 144 may be planar. The lid 142 may also include a plurality of receivers 148 that are configured to receive and secure a latch 170 such that each receiver 148 may receive an individual latch 170. In some embodiments, each receiver 148 may be located laterally outward of the top surface 144 and the lid protrusion 146. Additionally, each receiver 148 and its corresponding latch 170 may be centered along its respective wall 112, 114, 116, 118. In other embodiments, receivers and their corresponding latches may not be centered along their respective walls. A corner cap 150 may be formed between each receiver 148.

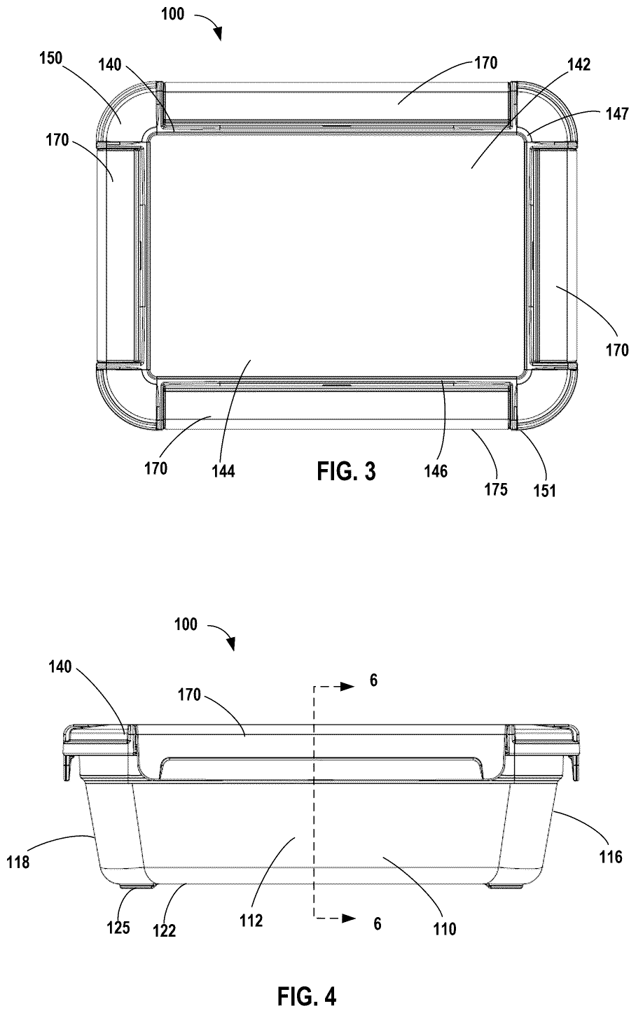

As shown in FIG. 3, when in the locked configuration, the outer surface 175 of the side wall 174 of each latch 170 may be substantially coplanar with an outer edge 151 of a corner cap 150 that is nearest to the latch 170. In addition, an upper surface 173 of the top wall 172 of each latch 170 may not extend beyond an upper surface 147 of the lid protrusion 146 when the latch 170 is in a locked configuration. In some examples, the upper surface 173 may be substantially coplanar with the upper surface 147 of the lid protrusion 146.

The lid 142 may also include a channel 152 on a bottom side 154 of the lid 142, where the channel 152 receives the gasket 200. The channel 152 may form a continuous loop which is located laterally outward of the top surface 144. The channel 152 may include a channel opening 156 that is open to the bottom side 154 of the lid 142 and an upper surface 158 opposite the channel opening 156. The channel 152 may be substantially U-shaped and/or may have substantially vertical side surfaces adjacent the upper surface 158. The upper surface 158 may include a channel rib 160 that extends away from the upper surface 158 toward the channel opening 156 and the bottom side 154 of the lid 142. The channel rib 160 may form a continuous loop within the channel 152. Additionally, in some embodiments, the channel rib 160 may be centered on the upper surface 158. The channel 152 may be positioned under each receiver 148 such that when a latch 170 is in a locked configuration, the top wall 172 of the latch 170 is located above the channel 152 and the gasket 200. The channel 152 may also be located laterally outward of axles 161 positioned in each receiver 148.

The plurality of receivers 148 may each be configured to individually secure a latch 170 of the plurality of latches 170. Each receiver 148 may comprise a pair of axles 161, where each axle 161 has a cylindrical portion 162 that extends inward from a side surface 164 of the receiver 148 and an end cap 166 at a free end of the axle 161. Each side surface 164 may be on opposite sides of the receiver 148 such that the pair of axles 161 extend toward each other. The cylindrical portion 162 may define an axis of rotation for each latch 170. The end cap 166 may have a maximum width that is larger than a maximum width and/or diameter of the cylindrical portion 162. The end cap 166 may not be centered on a longitudinal axis of the cylindrical portion 162 and may therefore be arranged asymmetrically with respect to the longitudinal axis of the cylindrical portion 162. In some examples, the end cap 166 may comprise a projection 167 that extends beyond the diameter of the cylindrical portion 162.

The plurality of latches 170 may be pivotally connected to the lid 142. Each latch 170 may include a pair of axle clips 178 that connect to the pair of axles 161 of each receiver 148. An axle clip 178 may include a rounded internal surface that allows the latch 170 to rotate around the cylindrical portion 162 of each axle 161. The axle clip 178 may connect to the cylindrical portion 162 of the axle 161 with a friction or snap fit. The latch 170 may also include a recess 181 adjacent to each axle clip 178. The recess 181 or at least a portion of the recess 181 may be located on an inner surface 180 of the top wall 172. Each recess 181 may receive a corresponding end cap 166 of each axle 161. In some examples, the projection 167 of the end cap 166 may contact and/or frictionally engage with recess 181 to help hold each latch 170 in an unlocked configuration. For examples, the frictional interface between the recess 181 and the end cap may hold the latch 170 in any angular position with respect to the lid 142 until acted upon by a user. Additionally or alternatively, an inward facing surface 165 of the end cap 166 may frictionally engage a side surface 179 of an axle clip 178 of the latch 170 to hold each latch 170 in an unlocked configuration such that the frictional interface between the side surface 179 and the inward facing surface 165 may hold the latch 170 in any angular position with respect to the lid 142 until acted upon by a user. The end cap 166 helps to prevent the axle clip 178 from coming off the axle 161 if the axle 161 or latch 170 were to deform or bend, such as when the container system 100 is dropped. The end cap 166 may also help to center the latch 170 within the receiver 148. In addition, the end cap 166 may also help to prevent the latch 170 from moving from a locked configuration to an unlocked configuration when the container system 100 is dropped or subject to an impact load to help improve the overall durability of the container system 100.

The container system 100 may include multiple features to ensure the gasket 200 provides a seal between the container 110 and the lid 142 to prevent any leakage of the contents out of the storage cavity 124 or any leakage of external fluids or debris into the storage cavity 124. The container 110 may include a container rib 139 that extends upward and away from an upper surface 135 of the perimeter lip 130. In some examples, the container rib 139 may form a continuous loop along the perimeter lip 130, while in other examples, it is contemplated that the container rib 139 may be intermittent. As discussed above, the channel 152 that receives the gasket 200 may include a channel rib 160 that extends downward from the upper surface 158 of the channel 152 toward the channel opening 156. The channel rib 160 and the container rib 139 may both contact the gasket 200 on opposite sides of the gasket 200 as shown in FIG. 7. In addition, in some embodiments the container rib 139 and the channel rib 160 may be substantially aligned to apply consistent pressure on the gasket 200. This consistent pressure on the gasket 200 helps to ensure a tight waterproof seal formed by the compression of the gasket 200. The gasket 200 may be compressed approximately 30 percent (e.g. measured in a cross-sectional profile) from an undeformed state or compressed within a range of 20 percent and 40 percent from an undeformed state, or in some examples, the gasket 200 may be compressed within a range of 15 percent and 40 percent from an undeformed state. The force to compress the gasket 200 may vary by container size. For example, a larger container with a larger gasket may require a larger force to sufficiently compress the gasket 200. The gasket 200 may also include a centrally located hollow cavity 202. Additionally, each latch 170 may include a latch rib 182 that extends away from an inner surface 180 of the top wall 172. When the latch 170 is in the locked configuration, the latch rib 182 may be located over the channel 152 and contact and exert a force on an outward facing surface 155 opposite the upper surface 158 of the channel 152. To further focus the pressure on the gasket 200, when the latch 170 is in the locked configuration, the latch rib 182 may be substantially aligned with the container rib 139. In some examples, the latch rib 182 may also be substantially aligned with the channel rib 160. Still in other examples, the latch rib 182, the channel rib 160, and the container rib 139 may all be substantially aligned with each other to focus the clamping force created by each latch 170 when in its locked configuration onto the gasket 200. In some such embodiments, the latch rib 182, the channel rib 160, and the container rib 139 may be disposed in a common plane when a latch 170 is in its locked configuration.

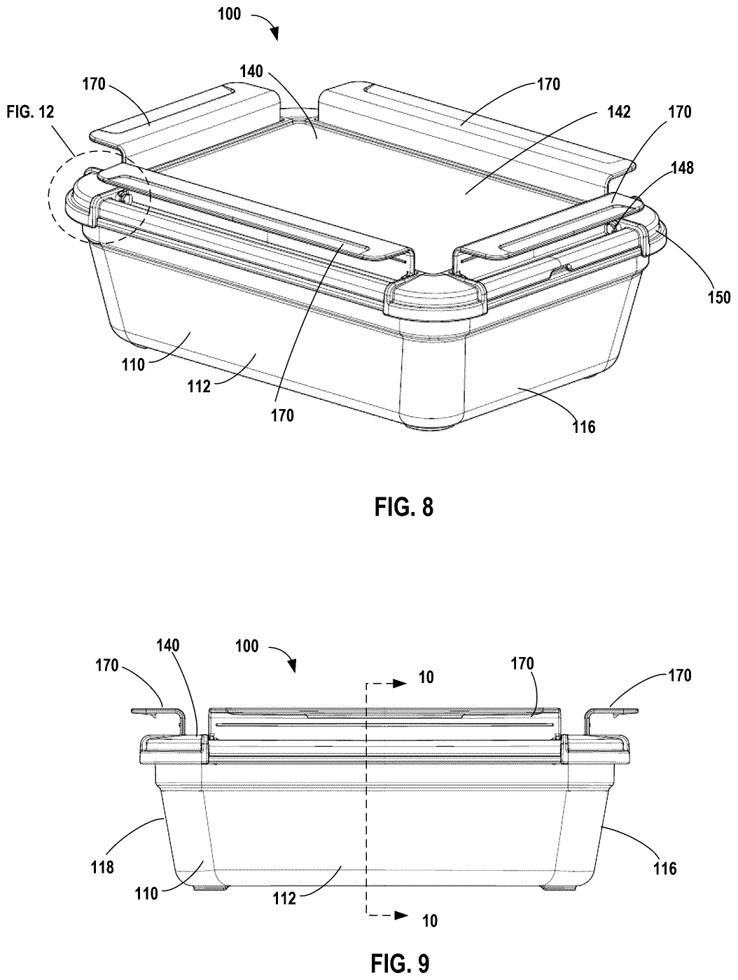

FIGS. 8-12 illustrate the container system 100 in an unlocked configuration. When the container system 100 is in an unlocked configuration, one or more latches 170 may be disengaged (e.g., free of contact) from the container 110. When one or more of the latches 170 are disengaged from the container 110, the pressure on the gasket 200 is reduced, thus permitting the seal between the gasket 200 and the container 110 to be released. To move the latch 170 to an unlocked configuration from a locked configuration, a user may rotate the latch 170 about its corresponding axles 161 in an upward direction such that the flange 176 is free of contact with the perimeter lip 130 and the latch rib 182 is also free of contact with an outward facing surface 155 opposite the upper surface 158 of the channel 152. In addition, the container system 100 may also include a restraint to prevent the latches 170 from accidentally moving when they are in an unlocked configuration. Each latch 170 may include a curved wall 184 connected to the top wall 172 opposite the side wall 174, where the curved wall 184 may have a restraint wall 186 that extends from an outer surface 188 of the curved wall 184. The restraint wall 186 may contact and in some cases, engage and rides over and/or move beyond a protrusion 169 extending upward from an upper surface 168 of the receiver 148 as the latch 170 is rotated upward. Once the restraint wall 186 contacts or moves beyond the protrusion 169, the latch 170 may be maintained in an unlocked configuration until a user applies a force to rotate the latch 170 downward toward the locked configuration to overcome the frictional and interference interaction between the restraint wall 186 and the protrusion 169. In some embodiments, the force applied to rotate a latch 170 toward the locked configuration may be greater than a non-zero threshold force.

FIGS. 19-22 illustrate an exemplary latch 170. As shown, the latch 170 may include a top wall 172 connected to a side wall 174, where the side wall 174 is substantially perpendicular to the top wall 172. The side wall 174 may further include a flange 176 that may extend inward and away from an inner surface 177 of the side wall 174. The latch 170 may have a latch length extending from a first end 183 of the top wall 172 to a second end 185 of the top wall 172. The latch rib 182 may have a latch rib length (e.g., a distance in the same direction as the latch length from the first end 183 to the second end 185) that is approximately 95 percent of the latch length to exert a consistent force onto the gasket 200. In some examples, the latch rib length may be within a range of 85 percent and 98 percent of the latch length. The latch rib 182 may also add localized stiffness to the top wall 172 to better allow consistent pressure on the gasket 200 to help maintain a seal. In addition, the latch rib 182 may be centered on the latch length, such that the latch rib 182 is centered upon a plane located at the midpoint of the latch length. The flange 176 may also be centered upon a plane at the midpoint of the latch length as well. The curved wall 184 of each latch 170 may extend the entire latch length as well and connect a portion of each axle clip 178. The outer surface 188 may include a restraint wall 186 that extends outward, where the restraint wall 186 may also be centered upon the latch length as well. As shown in FIG. 22, the latch 170 may include a recess 181 that is located adjacent to and inboard of each axle clip 178. For instance, each latch 170 may include two recesses 181 where each recess 181 is located adjacent a corresponding axle clip 178 in a direction toward a center of the latch 170. A portion of each recess 181 may be located on an inner surface 180 of the top wall 172 and have a curved surface to allow for the rotation of the latch 170 around end cap 166 of the axle 161. The axle clips 178 may have a curved inner surface and be configured to pivotally connected to the cylindrical portion 162 of the axle 161 of the lid 142.

FIGS. 23-24 illustrate the container 110. As discussed above, the container 110 may include a container body 111 that has a first wall 112, a second wall 114 opposite the first wall 112, a third wall 116 extending between the first wall 112 and the second wall 114, and a fourth wall 118 opposite the third wall 116 extending between the first wall 112 and the second wall 114. A bottom wall 120 may connect the first wall 112, the second wall 114, the third wall 116, and the fourth wall 118 at a bottom end 122 of the container 110 forming a storage cavity 124 with a container opening 126 opposite the bottom wall 120 at an upper end 128 of the container 110. A step 129 may extend along the walls 112, 114, 116, and 118 such that the step is substantially parallel with the bottom wall 120. The step 129 reduces the width across the container 110 and may allow additional space for a user to fit their hand under the side wall 174 of the latch 170 to easily rotate the latch 170 from a locked configuration to an unlocked configuration. The step 129 may also assist in allowing the multiple containers 110 to stack or nested together for storage.

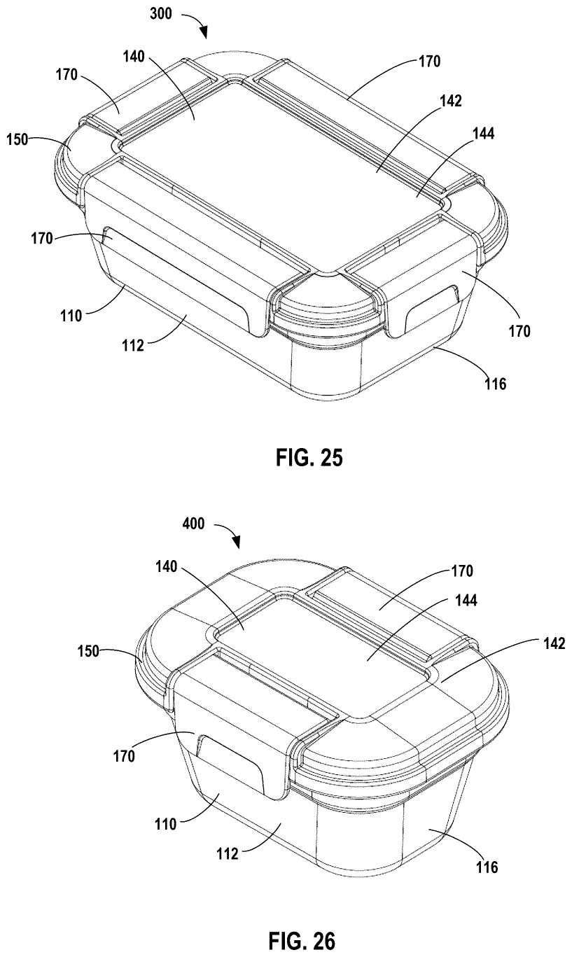

In some examples, the number of receiver 148 and latches 170 may be equal to the number of walls of the container 110. For example, in the illustrated examples shown in FIGS. 1-24, the lid assembly 140 includes four latches 170 which is equal to the number walls of the container 110. The container system 100 may have different sizes as shown in FIGS. 25 and 26. The container systems 300 and 400 illustrated in FIGS. 25 and 26 respectively may have all of the same features as the container system 100 shown in FIGS. 1-24. As the container system 400 of FIG. 26 is smaller in size than container system 300, the lid assembly 140 may comprise only two latches and still provide the necessary force to compress the gasket to adequately seal the container system 400. Optionally, on smaller container systems such as container system 400 illustrated in FIG. 26, the lid assembly 140 may comprise only two latches 170 that are arranged opposite each other with the smaller sides of the container system 400 not having a latch.

The container 110, the lid 142, and the latches 170 may be formed from a polymeric material using a molding process, such as injection molding or other molding process known to one skilled in the art. The polymeric material may be a clear polymeric material that allows a user to see the contents in the storage cavity 124. In addition, the polymeric material of the container 110 and the lid 142 may be a food safe material such as Tritan™. In some examples, the container 110 may be formed from a glass material.

While various embodiments have been described, it will be apparent to those of ordinary skill in the art that many more embodiments and implementations are possible that are within the scope of the claims. The various dimensions described above are merely exemplary and may be changed as necessary. Accordingly, it will be apparent to those of ordinary skill in the art that many more embodiments and implementations are possible that are within the scope of the claims. Therefore, the embodiments described are only provided to aid in understanding the claims and do not limit the scope of the claims.

We claim:

1. A container system, comprising:
a container comprising:
a first wall;
a second wall opposite the first wall;
a third wall extending between the first wall and the second wall;
a fourth wall opposite the third wall extending between the first wall and the second wall;
a bottom wall connected to the first wall, the second wall, the third wall, and the fourth wall at a bottom end of the container forming a storage cavity with a container opening opposite the bottom wall; and
a perimeter lip extending laterally outward around at least a portion of a perimeter of the container opening, wherein the perimeter lip includes a lip protrusion extending from a lower surface of the perimeter lip; and
a lid assembly releasably connected to the container, wherein the lid assembly covers the container opening when connected to the container, wherein the lid assembly comprises:
a lid that includes a top surface and a channel on a bottom side of the lid;
a gasket received in the channel; and
a latch pivotally connected to the lid, wherein the latch includes a latch rib, such that when the latch is engaged with the perimeter lip of the container, the latch rib is located over the channel of the lid.

2. The container system of claim 1, wherein the channel includes an upper surface that has a channel rib that extends away from the upper surface toward the bottom side of the lid, and wherein the latch rib and the channel rib are substantially aligned when the latch is engaged with the lip protrusion of the container.

3. The container system of claim 2, wherein the container includes a container rib that extends upward and away from an upper surface of the perimeter lip.

4. The container system of claim 3, wherein the container rib is substantially aligned with the channel rib and the latch rib.

5. The container system of claim 2, wherein the channel forms a continuous loop, and the channel rib also forms a continuous loop.

6. The container system of claim 3, wherein the container rib and the channel rib contact the gasket on opposite sides of the gasket.

7. The container system of claim 1, wherein the latch rib contacts an outward facing surface of the lid opposite the channel.

8. The container system of claim 1, wherein the lid comprises a receiver that includes a first axle that extends from a first side surface of the receiver and a second axle that extends from a second side surface of the receiver.

9. The container system of claim 8, wherein the first axle includes a cylindrical portion and an end cap at a free end, wherein an axle clip of the latch connects to the cylindrical portion, and
wherein the end cap has a maximum width that is larger than a diameter of the cylindrical portion.

10. The container system of claim 1, wherein the latch includes a top wall connected to a side wall, wherein the side wall is substantially perpendicular to the top wall, wherein the side wall includes a flange that engages the perimeter lip, and
wherein the latch rib extends outward from an inner surface of the top wall.

11. The container system of claim 10, wherein the latch has a latch length extending from a first end of the top wall to a second end of the top wall, and the latch rib has a latch rib length, wherein the latch rib length is within a range of 85 percent to 98 percent of the latch length.

12. A lid assembly for a covering an opening of a container, the lid assembly comprising:
a lid that includes a top surface and a channel on a bottom side of the lid, wherein the channel includes an upper surface that has a channel rib that extends away from the upper surface toward the bottom side of the lid;
a gasket received in the channel; and
a latch pivotally connected to the lid, wherein the latch is configured to rotate between a locked configuration and an unlocked configuration, wherein the latch includes a latch rib, such that when the latch is in the locked configuration the latch rib contacts an outward facing surface of the lid opposite the channel, and when the latch is in the unlocked configuration, the latch rib is free of contact with the outward facing surface of the lid opposite the channel.

13. The lid assembly of claim 12, wherein the latch rib and the channel rib are substantially aligned when the latch is in the locked configuration.

14. The lid assembly of claim 12, wherein the latch includes a top wall connected to a side wall, wherein the side wall is substantially perpendicular to the top wall, wherein the side wall includes a flange that is configured to engages a perimeter lip of the container when the latch is in the locked configuration.

15. The lid assembly of claim 13, wherein the latch rib is configured to apply a force to the gasket through the channel rib when the latch is moved to the locked configuration.

16. A container system, comprising:
a container comprising:
a container body including a storage cavity that is accessed through a container opening; and
a perimeter lip extending laterally outward around at least a portion of a perimeter of the container opening, wherein the perimeter lip includes:
a lip protrusion extending from a lower surface of the perimeter lip; and
a container rib that extends upward and away from an upper surface of the perimeter lip; and
a lid assembly releasably connected to the container, wherein the lid assembly covers the container opening when connected to the container, wherein the lid assembly comprises:
a lid that includes a top surface, a channel located on a bottom side of the lid, wherein the channel includes an upper surface that has a channel rib that extends away from the upper surface toward the bottom side of the lid, and a plurality of receivers positioned laterally outward of the top surface, wherein a first receiver of the plurality of receivers includes a first side surface and a second side surface, and wherein a first axle extends from the first side surface and a second axle extends from the second side surface;
a gasket received in the channel; and
a plurality of latches, wherein a first latch of the plurality of latches includes a top wall, a side wall connected to the top wall, and a pair of axle clips extending from an inner surface of the top wall, wherein the side wall includes a flange that engages a bottom surface of the lip protrusion of the perimeter lip when container system is in a locked configuration to compress the gasket between the container rib and the channel rib.

17. The container system of claim 16, wherein the first axle includes a cylindrical portion and an end cap at a free end, wherein an axle clip of the pair of axle clips connects to the cylindrical portion.

18. The container system of claim 16, wherein the first latch further includes a curved wall connected to the top wall opposite the side wall, wherein the curved wall has an outer surface that includes a restraint wall, wherein when the first latch is rotated upward to an unlocked configuration, the restraint wall contacts a protrusion extending upward from an upward facing surface of the first receiver.

19. The container system of claim 16, wherein the first latch further includes a latch rib that extends from the inner surface of the top wall, and wherein when the first latch is in the locked configuration, the latch rib contacts an outward facing surface of the lid opposite the channel.

20. The container system of claim 16, wherein the channel is located laterally outward of the first axle and the second axle of each receiver.
